(19) United States
(12) Patent Application Publication
(10) Pub. No.: US 2026/0339383 A1
(43) Pub. Date: Oct. 29, 2026

(54) CLOCK SIGNAL DRIFT MITIGATION IN A MULTI-CHIP INTEGRATED CIRCUIT DEVICE

(71) Applicant: ATI Technologies ULC, Markham (CA)

(72) Inventors: Shaofeng AN, Markham (CA); YanFeng WANG, Ontario (CA); Laurent TEA, Markham (CA)

(21) Appl. No.: 19/193,835

(22) Filed: Apr. 29, 2025

(51) Int. Cl. G06F 1/08; G06F 1/14

(52) U.S. Cl. CPC G06F 1/08; G06F 1/14

(57) ABSTRACT

A multi-chip integrated circuit (IC) device includes a first IC chip, and a second IC chip. The second IC chip is connected to the first IC chip via interface circuitry. The second IC chip receives a clock signal and a track signal from the first IC chip. Further, the second IC chip outputs a first control signal to the first IC chip. The first control signal includes an indication to adjust the clock signal based on determining that the clock signal is not aligned with the track signal. The second IC chip receives the adjusted clock signal from the first IC chip.

### TECHNICAL FIELD

Examples of the present disclosure generally relate to integrated circuit (IC) design, and in particular to a multi-chip IC that uses phase adjustment within the transmitter circuitry to calibrate the receiver circuitry.

### BACKGROUND

Multiple integrated circuit (IC) dies device use modular chiplets over traditional monolithic chips to increase design flexibility and reduced cost. Interconnecting IC dies (e.g., chiplets) within a single package through chip-to-chip (C2C), or die-to-die (D2D), interfaces enables an ecosystem supporting dis-aggregated die architectures having different protocols and functionalities. The Universal Chiplet Interconnect express (UCIe) interface allows for the integration of multiple IC dies within a common package, and for the IC dies to communicate with each other.

The IC dies of a multiple IC die device include transceiver circuitries that are used to transmit data, and other types of signals, between IC dies. The transceiver circuitries may be high-speed transceiver circuitries. The transceiver circuitries communicate clocks signals between the IC dies. The clock signals are used by the interface circuitries of the transceiver circuitries to communicate and/or process data signals. The clock signals are aligned with the communicated data signals. Overtime, the clock signals may drift due to operating temperature variations and/or operating voltage variations. Clock drift within the clock signals can be compensated for by using receiver phase generator circuitry. However, the current processes are expensive to implement, increasing the cost of manufacturing the corresponding semiconductor device. The clock drift compensation method described in the following uses the clock adjustment circuitry within transceiver circuitry to adjust for clock drift detected within another transceiver circuitry, reducing the cost of the corresponding semi-conductor device.

### SUMMARY

In one example, a multi-chip integrated circuit (IC) device includes a first IC chip, and a second IC chip. The second IC chip is connected to the first IC chip via interface circuitry. The second IC chip receives a clock signal and a track signal from the first IC chip. Further, the second IC chip outputs a first control signal to the first IC chip. The first control signal includes an indication to adjust the clock signal based on determining that the clock signal is not aligned with the track signal. The second IC chip receives the adjusted clock signal from the first IC chip.

In one example, an IC chip receives a clock signal and a track signal from a second IC chip. The second IC chip is connected to the IC chip via interface circuitry. Further, the IC chip outputs a first control signal to the second IC chip. The first control signal includes an indication to adjust the clock signal based on determining that the clock signal is not aligned with the track signal. The IC chip further receives the adjusted clock signal from the second IC chip.

In one example, a method includes receiving, at a first IC chip, a clock signal and a track signal from a second IC chip. The first IC chip is connected to the second IC chip via interface circuitry. The method further includes outputting, from the first IC chip, a first control signal to the second IC chip. The first control signal includes an indication to adjust the clock signal based on determining that the clock signal is not aligned with the track signal. Further, the method includes receiving, at the first IC chip, the adjusted clock signal from the second IC chip.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A illustrates a block diagram of a multi-chip integrated circuit (IC) device including two chips coupled to each other through interface circuitries.

FIG. 1B illustrates a block diagram of a multi-chip IC device including two chips coupled to each other through interface circuitries.

FIG. 2 illustrates is a block diagram of an electronic device including portions of a first IC chip and portions of a second IC chip coupled to each other through interface circuitry.

FIG. 3 illustrates a flowchart of a method for mitigating drift in a clock signal.

FIG. 4 illustrates a waveform diagram of a clock signal and a track signal, wherein the clock signal is not aligned with the track signal.

FIG. 5 illustrates a waveform diagram of a clock signal and a track signal, wherein the clock signal is aligned with the track signal.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive explanation of the description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

In a multi-chip (or multi-die) integrated circuit (IC) device, two or more chips are interconnected with each other. A first IC chip communicates clock and data signals to a second IC chip. The second IC chip uses the received clock signal to receive and process the data signals. A chip-to-chip (C2C) interface is used to control the communication between the chips. The C2C interface is used to transmit clock signals and data signals between the chips of the C2C interface. The C2C interface includes circuitry within the two or more chips, and wires connecting the two or more chips with each other.

The IC chips include transceiver circuitries that use the C2C interface to communicate with each other. The transceiver circuitry includes transmitter circuitry and receiver circuitry. The transmitter circuitry of the transceiver circuitry of a first IC chip communicates clock signals and data signals to the receiver circuitry of the transceiver circuitry of a second IC chip. The clock signals are used by the receiver circuitry to receive and process the data signals.

After a period of time, the clock signals may experience drift due to a change in an operational temperature and/or a change in an operational voltage. The drift decreases the ability of the receiver circuitry to properly receive and process the data signals. Current processes for mitigating drift within the clock signals, and calibrating clock signals use phase adjustment within the receiver circuitry. However, performing the mitigation and/or calibration within the receiver circuitry is complex and expensive to implement. Accordingly, the cost of the semiconductor device is increased. Further, as the mitigation and/or calibration techniques are complex and expensive to implement, the techniques and corresponding circuitries are often omitted from the receiver circuitries.

The system and method to calibrate the clock signals to mitigate drift as described herein use phase adjustments within the transmitter circuitry to adjust the clock signals based on differences between a clock signal and a tracking signal within the receiver circuitry. The receiver circuitry compares the clock signal with the tracking signal. The receiver circuitry instructs the transmitter circuitry to adjust the clock signal (e.g., increase the phase of the clock signal or decrease the phase of the clock signal) based on differences between clock signal and the tracking signal. Accordingly, drift within the clock signal can be mitigated without the need for complex and expensive circuitry and/or processes included within the receiver circuitry, reducing the cost of the corresponding semiconductor device. Further, the corresponding semiconductor device is able to perform runtime mitigation and compensation of clock signal drift.

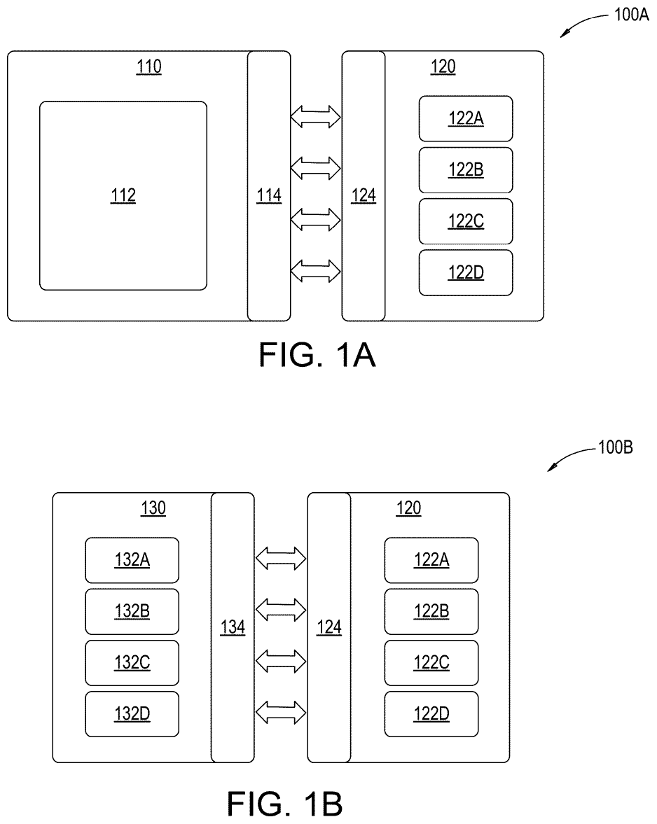

FIG. 1A illustrates a block diagram of a multi-chip IC device 100A including IC chips 110 and 120 coupled to each other through C2C interface circuitry, or interface circuitry. The IC chips may be referred to as IC chiplets.

As illustrated in FIG. 1A, the IC chip 110 includes programmable logic 112 and a C2C interface circuitry 114. By way of example only, the programmable logic 112 may at least partially be provided by one or more of field programmable gate arrays (FPGAs). The programmable logic 112 may accommodate one or more look up tables (LUTs) and other logic in configurable logic blocks (CLBs). The programmable logic 112 may be programmed to perform a wide variety of functions corresponding to the particular end-user applications. The interface circuitry 114 may include a protocol layer, a D2D adapter layer and a PHY layer, not explicitly shown in FIG. 1A. The interface circuitry 114 is implemented on the IC chip 110 to transmit data to and receive data from another IC chip, such as the IC chip 120. In another example, the IC chip 110 may include Application Specific Integrated Circuits (ASICs) coupled to the interface circuitry 114 to transmit data to and receive data from another IC chip, such as the IC chip 120.

The interface circuitry 114 may be a Universal Chiplet Interconnect express (UCIe) interface. In other examples, the interface circuitry 114 may be another type of interface. The UCIe interface supports high-speed low-latency communication between the IC chips.

In one or more examples, the IC chip 110 is an anchor chiplet or another type of chiplet. The IC chip 110 may include circuitry comprising one or more data processing blocks, such as a processing system or subsystem (PS), a memory system (e.g., including a memory controller), and the like, to handle data provided by or to the IC chip 120.

As illustrated in FIG. 1A, the IC chip 120 includes one or more transceiver circuitries 122A, 122B, 122C, and 122D (collectively referred to as transceiver circuitries 122), and interface circuitry 124. In another example, each of the transceiver circuitries 122 may be coupled to separate interface circuitry 124. One or more of the transceiver circuitries may be a Gigabit transceiver, or another type of transceiver. The IC chip 120 may also include other intellectual property (IP) blocks such as a Peripheral Component Interconnect Express (PCIe)/Cache Coherent Interconnect for Accelerators (CCIX) media access control (MAC) core associated with a Processor Subsystem (PS) and direct memory access (DMA) engines and controllers, all of which are omitted from FIG. 1A for clarity.

In one or more examples, the IC chip 120 is a Medium Access Control (MAC) PCIe Chiplet (GMPC), which is a multi-function high-speed I/O chiplet. The IC chip 120 may include programmable circuitry that is able handle a wide spectrum of applications. The IC chip 120 may handle GT direct applications with protocols implemented in the programmable logic 112 with different configurations. Examples of the protocols that the IC chip 120 can handle may include, but are not limited to, Ethernet, synchronous Ethernet (SyncE), PCIe-Test and Measurement (PCIe-T&M), Joint Electron Device Engineering Council (JEDEC) Serial Interface for Data Converters (JESD), Optical Interconnect Forum-Common Electrical Interface (OIF-CEI), Interlaken (ILKN), Common Public Radio Interface (CPRI), and Advanced Microcontroller Bus Architecture (AMBA) Advanced eXtensible Interface 4 (AXI-4).

The transceiver circuitries 122 may be individually programmed to conform to different standards or protocols. In addition, the transmitter and receiver paths of each transceiver circuitry 122 may be separately programmed such that the transmitter path of the transceiver can support one standard or protocol while the receiver path of the same transceiver can support a different standard or protocol. Further, two or more transceiver circuitries 122 may be bonded together to provide faster transmission speed and/or greater bandwidth. Each of the transceiver circuitries 122 may perform a serial-to-parallel conversion on received data and perform a parallel-to-serial conversion on the corresponding data.

In some embodiments, each of the transceiver circuitries 122 may achieve a bandwidth of 1.25 gigabits per second (Gbps) to 112 Gbps per data lane, and an aggregated bandwidth of up to 1.6 terabits per second (Tbps) on a single data link. In some embodiments, the IC chip 120 may also include PCIe Gen6 AXI-S and DMA AXI-MM interfaces (not explicitly shown in FIG. 1A) with many possible bifurcation configurations (e.g., x2, x4, x8, x16, or any combination thereof). In some embodiments, the IC chip 120 may support Ethernet MAC AXI-S with a variety of possible port configurations (e.g., 10G, 25G, 50G, 100G, 200G, 400G, 800G, 1.6T, etc.).

The IC chip 120 may be coupled to the IC chip 110 via the interface circuitries 114 and 124, and physical or hardwired connections. The interface circuitries 114 and/or 124 are programmable (for example, via a programming software model employing a programming interface for the end user). In some embodiments, the interface circuitries 114 and/or 124 comprise digital and analog components that enable communication between two or more chiplets.

In one or more examples, while one IC chip 120 is illustrated as being coupled to the IC chip 110 (e.g., an anchor chiplet) in the multi-chip IC device 100A, the IC chip 110 can support multiple IC chips having a homogeneous arrangement of a single type of IC chips 120 or having a heterogeneous arrangement of more than one type of IC chips 120.

FIG. 1B illustrates a block diagram of a multi-chip IC device 100B including IC chips (chiplets) 120 and 130 coupled to each other through interface circuities. In one or more examples, the IC chip 120 may correspond to the IC chip 120 in FIG. 1A. The IC chip 130 includes transceiver circuitries 132A, 132B, 132C, and 132D (collectively referred to as “the transceiver circuitry 132”), and interface circuitry 134. In an example, the IC chip 130 may perform substantially similar functions and support substantially similar protocols as the IC chip 120. In another example, the IC chip 130 may perform different functions and support different protocols from the IC chip 120. The transceiver circuitries 122 in the IC chip 120 and the transceiver circuitries 132 in the IC chip 130 may communicate with each other through the interface circuitries 124 and 134.

It should be noted that the scope of various aspects of the present disclosure should not be limited by characteristics (e.g., types of chiplets, transceiver protocols, bandwidths, clock frequencies, etc.) of the multi-chip IC devices shown in FIGS. 1A and 1B.

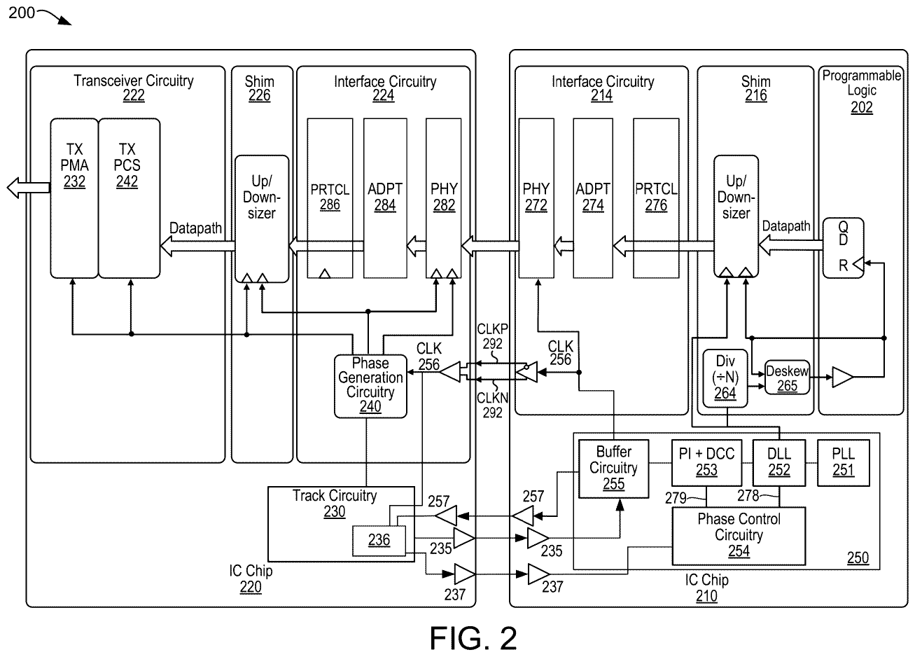

FIG. 2 illustrates a block diagram of an electronic device 200 showing portions of an IC chip 210 and portions of an IC chip 220 connected to each other interface circuitry. In one example, data is transmitted from the IC chip 210 (e.g., an anchor IC chip) to the IC chip 220. In one example, the IC chip 210 and 220 shown in FIG. 2 correspond to the IC chips 110 and 120 of FIG. 1A.

The IC chip 210 includes programmable logic 202 and interface circuitry 214. In one example, the interface circuitry 214 is UCIe interface circuitry. The interface circuitry 214 includes transmitter circuitry. While not illustrated, the interface circuitry 214 further includes receiver circuitry. The interface circuitry 214 physical (PHY) layer circuitry 272, adapter layer circuitry 274, and protocol layer circuitry 276.

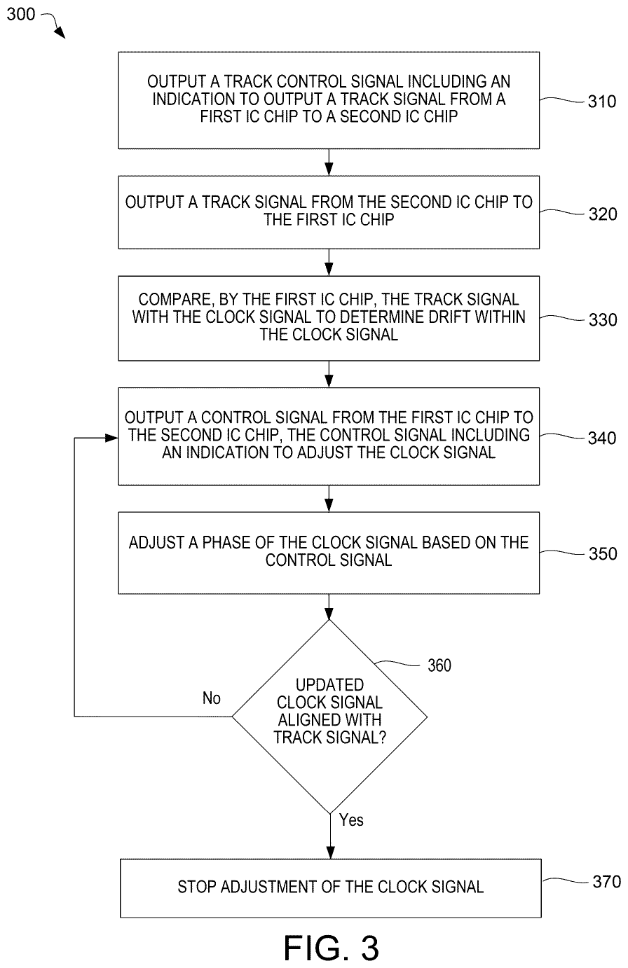

The IC chip 220 includes transceiver circuitry 222 and interface circuitry 224. The interface circuitry 224 includes receiver circuitry and transmitter circuitry (not shown in FIG. 3). The interface circuitry 224 includes PHY layer circuitry 282, adapter circuitry 284 circuitry, and protocol layer circuitry 286.

As illustrated in FIG. 2, the IC chip 210 may include a shim circuitry 216 between the programmable logic 202 and the interface circuitry 214. The IC chip 220 may include shim circuitry 226 between the transceiver circuitry 222 and the interface circuitry 224. It should be understood that a shim architecture (e.g., the shim circuitry 216 or 226) may allow higher bit-width channels running at lower frequencies to be connected lower bit-width channels running at higher frequencies.

The transceiver circuitry 222 includes a programmable physical media attachment (PMA) circuitry, a programmable physical coding sub-layer (PCS) circuitry, and a clock management circuitry. The PMA circuitry includes a programmable transceiver (TX) PMA circuitry 232 and programmable RX PMA circuitry (not illustrated). The programmable PCS circuitry includes programmable TX PCS circuitry 242 and programmable RX PCS circuitry (not illustrated). The IC chip 220 further includes clock generation circuitry 250.

In one example, the programmable TX PCS circuitry 242 receives TX data from the interface circuitry 224 through the shim circuitry 226, and converts the data into parallel data, for example, in accordance with a TX PMA PCS interface setting (or another interface setting). The programmable TX PMA circuitry 232 may further convert the parallel data from the programmable TX PCS circuitry 242 into transmit serial data, for example, in accordance with a programmed serialization setting (or another setting).

The IC chip 210 further includes clock generation circuitry 250. The clock generation circuitry 250 generates and outputs the clock signal 256 and the track signal 257. In one example, the track signal 257 is the same as the clock signal 256. The track signal 257 is communicated to the IC chip 220 as a single ended signal. The clock signal 256 is communicated to the IC chip 220 as a differential clock signal 292.

The clock generation circuitry 250 includes phase-locked loop (PLL) circuitry 251, delay-locked loop (DLL) circuitry 252, phase interpolator and duty cycle correction (PI+DCC) circuitry 253, phase control circuitry 254, and buffer circuitry 255. In other examples, the clock generation circuitry 250 may include additional and/or alternative circuit elements. For example, the clock generation circuitry 250 may additionally, or alternatively, include frequency-locked loop (FLL) circuitry, harmonic mixer circuitry, and/or frequency multiplier circuitry, among others.

The PLL circuitry 251 generates a clock signal that is output to the DLL circuitry 252. The DLL circuitry 252 receives the clock signal output by the PLL circuitry 251, and applies one or more delays to the clock signal to adjust a phase of the clock signal to generate an adjusted clock signal. The PI+DCC circuitry 253 receives the adjusted clock signal from the DLL circuitry 252, and the PI+DCC circuitry 253 further adjusts the phase of the adjusted clock signal. In one example, the DLL circuitry 252 applies coarse changes to the phase of the clock signal, and the PI+DCC circuitry 253 applies fine changes to the phase of the clock signal. The phase changes applied by the DLL circuitry 252 and the PI+DCC circuitry 253 are controlled by control signals provided by the phase control circuitry 254. The phase control circuitry 254 outputs a control signal to the DLL circuitry 252 and a control signal to the PI+DCC circuitry 253 indicating to increase or decrease the phase of the clock signal. In one example, the DLL circuitry 252 and PI+DCC circuitry 253 may be combined and referred to as clock phase circuitry.

The buffer circuitry 255 receives the phase adjusted clock signal from the PI+DCC circuitry 253, and generates and outputs the clock signal 256 and the track signal 257 from the phase adjusted clock signal.

The buffer circuitry 255 outputs the clock signal 256 to the PHY layer circuitry 272, which uses the clock signal 256 in the communication of a data signal to the IC chip 220.

The phase generation circuitry 240 of the IC chip 220 receives the clock signal 256 and generates clock signals for the PHY layer circuitry 282, the shim circuitry 226, and the transceiver circuitry 222. The phase generation circuitry 240 may increase and/or decrease the frequency and/or phase of the clock signal 256 to generate the output clock signals.

The PHY layer circuitry 282 receives the clock signal output the by phase generation circuitry 240, and uses the clock signal to receive and process the data signal communicated by the PHY layer circuitry 272. Further, the shim circuitry 226 uses one or more clock signal output by the phase generation circuitry 240 to process the data signal received from the PHY layer circuitry 282 via the adapter circuitry 284. The shim circuitry 226 increases or decreases a frequency of the data signal based on the received clock signals. The adjusted data signal is output to the transceiver circuitry 222. The transceiver circuitry 222 generates an output data signal based on a clock signal (or signals) output from the phase generation circuitry 240. In one example, the programmable TX PCS circuitry 242 receives a data signal from the interface circuitry 224 through the shim circuitry 226, and converts the data into parallel data based on a received clock signal. The programmable TX PMA circuitry 232 may further convert the parallel data from the programmable TX PCS circuitry 242 into serial data, for example, in accordance with a programmed serialization setting, based on a received clock signal.

In one or more examples, the phase adjusted clock signal generated by the DLL circuitry 252 is output to the divider circuitry 264. The divider circuitry 264 divides the frequency of the received clock signal by N, where N is two or more. The divided clock signal is output from the divider circuitry 264 and received by the deskew circuitry 265, which uses a feedback loop to remove skew from the divided clock signal. The output of the deskew circuitry 265 is used by the programmable logic 202 to generate a data signal to be transmitted.

The track circuitry 230 receives the track signal 257. The track circuitry 230 further receives the clock signal 256. The track circuitry 230 compares the track signal 257 with the clock signal 256 to detect drift within the clock signal 256. In one example, the clock signal 256 is a differential clock signal 292 including clock signal CLKP and CLKN. In such an example, the track circuitry 230 receives the clock signal CLKP or the CLKN, and compares the clock signal CLKP or CLKN to the track signal 257 to detect drift within the clock signal.

The track circuitry 230 generates and outputs the control signal 237 based on the detection of drift within the clock signal. The control signal 237 includes an indication to adjust the phase of the clock signal output by the IC chip 210. In one example, the control signal 237 includes an indication to increase or decrease the phase of the clock signal 256. Adjusting the phase of the clock signal 256 brings the phase of the clock signal 256 to be aligned with the phase of the track signal 257.

In one example, the track circuitry 230 includes comparator circuitry 236. The comparator circuitry 236 receives the track signal 257. The comparator circuitry 236 further receives the clock signal 256. In one example, receiving the clock signal 256 includes receives the differential clock signal CLKP 292 or CLKN 292. The comparator circuitry 236 compares the track signal 257 with the clock signal 256 to detect drift within the clock signal 256. In an example where the clock signal 256 is a differential clock signal 292 including clock signal CLKP and CLKN, the comparator circuitry 236 receives the clock signal CLKP or the CLKN, and compares the clock signal CLKP or CLKN to the track signal 257 to detect drift within the clock signal. The comparator circuitry 236 generates the control signal 237 based on a detected phase difference between the clock signal and the track signal 257.

The phase control circuitry 254 receives the control signal 237 and generates one or more controls signals (e.g., control signal 278 and/or control signal 279) indicating a phase increase or phase decrease to the DLL circuitry 252 and/or the PI+DCC circuitry 253.

FIG. 3 illustrates a flowchart of a method 300 for mitigating drift within a clock signal. The method 300 is performed by the electronic device 200 of FIG. 2. At operation 310 of the method 300, a control signal (track control signal) including an indication to generate and output a track signal is output from a first IC chip to a second IC chip. With reference to FIG. 2, the IC chip 220 generates the control signal 235, and outputs the control signal 235 to the IC chip 210. The control signal 235 includes an indication to generate and output a track signal. The IC chip 210 receives the control signal 235 and outputs the track signal 257 based on receiving the control signal 235.

In one example, the track circuitry 230 generates and outputs the control signal 235. The track circuitry 230 generates and outputs the control signal 235 based on the passing of a period of time, the detection of a change in operating parameters (e.g., temperature and/or voltage), or an externally received control signal. The control signal 235 is received by the buffer circuitry 255.

At operation 320, a track signal is output from the second IC chip to the first IC chip. In one example, the IC chip 210 outputs (communicates) the track signal 257 to the IC chip 220. The IC chip 210 generates and outputs the track signal 257 based on receiving the control signal 235. In one example, the buffer circuitry 255 generates and outputs the track signal 257 based on receiving the control signal 235. The track signal 257 is communicated to the track circuitry 230. In one example, the track signal 257 is communicated to and received by the comparator circuitry 236.

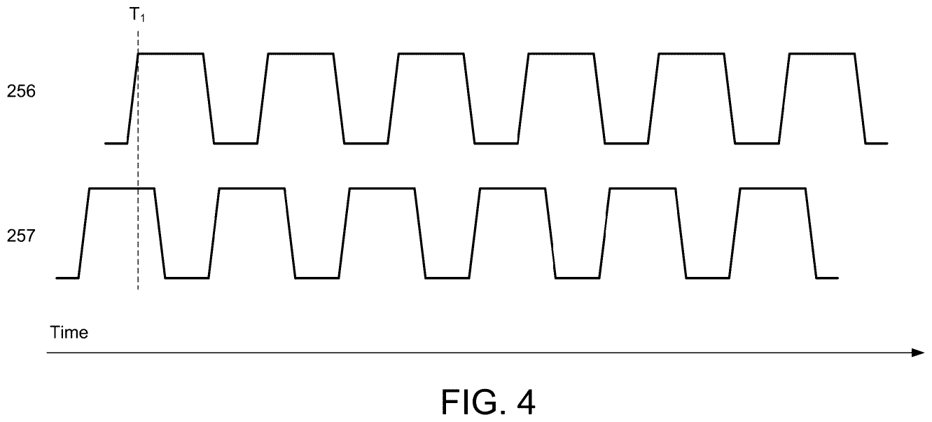

FIG. 4 illustrates waveforms of the clock signal 256 and track signal 257. As can be seen from FIG. 4, the clock signal 256 and the track signal 257 are varying voltage signals. The clock signal 256 and the track signal 257 include a pattern of 1's and 0's. The clock signal 256 and the track signal 257 have the same duty cycle.

At operation 330, the track signal is compared with the clock signal to determine drift within the clock signal. In one or more examples, the IC chip 220 receives the track signal 257 and compares the track signal with the clock signal 256 to determine drift within the clock signal 256. In one example, the clock signal compared to the track signal 257 is the differential clock signal CLKP 292 or the differential clock signal CLKN 292.

In one example, the tracking circuitry 274 samples the track signal 257 and the clock signal, and compares the values of the corresponding samples to each other to determine if the clock signal has experienced drift. The track circuitry 230 includes comparator circuitry 236 that compares the track signal 257 with the clock signal to determine if the clock signal 256 differs from the track signal 257. Any differences between the clock signal 256 and the track signal 257 correspond to drift within the clock signal 256. Differences between the clock signal 256 and the track signal 257 are differences in phase between the clock signal 256 and the track signal 257. The comparator circuitry 236 samples the track signal 257 and the clock signal 256. The comparator circuitry 236 compares the values of corresponding samples of the track signal 257 and the clock signal 256 to each other to determine if the clock signal 256 has experienced drift. In one example for a given sample period, if the sampled value of the clock signal 256 differs from the sampled value of the track signal 257, drift of the clock signal 256 is determined. In FIG. 4, at time T₁, the clock signal 256 differs from the track signal 257. Accordingly, drift of the clock signal 256 is determined.

At operation 340 of the method 300, a control signal indicating to adjust the clock signal is output from the first IC chip to the second IC chip. In one example, the IC chip 220 generates and outputs the control signal 237 to the IC chip 210. The control signal 237 includes an indication to adjust the clock signal 256. Adjusting the clock signal includes adjusting a phase of the clock signal 256. In one example, the control signal 235 includes a pattern of 1's and 0's that are indicative to increase the phase of the clock signal 256, decrease the phase of the clock signal 256, or to not adjust the phase of the clock signal 256. In one example, the control signal 235 includes an indication to increase the phase of the clock signal 256 by one or more steps or to decrease the phase of the clock signal 256 by one or more steps.

At operation 350 of the method 300, the phase of the clock signal is adjusted based on the control signal. For example, the IC chip 210 receives the control signal 237, and adjusts the phase of the clock signal 256 based on the control signal 237. The phase of the clock signal 256 is increased or decreased based on the indication of the control signal 237. In one example, the clock signal 256 is increased or decreased by one or more phase steps based on the indication of the control signal 237.

In one example, the phase control circuitry 254 receives the control signal 237, and generates the control signal 278 and/or the control signal 279. The phase control circuitry 254 generates the control signal 235 based on receiving the control signal 237 and based on the indication to increase or decrease the phase of the clock signal 256. In one example, the phase control circuitry 254 generates the control signal 278 having an indication to increase or decrease the phase of the control signal by the DLL circuitry 252. Additionally, or alternatively, the phase control circuitry 254 generates the control signal 279 having an indication to increase or decrease the phase of the control signal by the PI+DCC circuitry 253. The control signals 278 and 279 may each be generated, or one of the control signal 278 and 279 are generated based on the control signal 237.

The DLL circuitry 252 receives the control signal 278 and increases or decreases the phase of the clock signal output by the PLL circuitry 251. Additionally, or alternatively, the PI+DCC circuitry 253 receives the control signal 279 and increases or decreases the phase of the clock signal output by the DLL circuitry 252. In one example, the control signal 278 and/or 279 updates the PI code used by the DLL circuitry 252 and/or the PI+DCC circuitry 253.

The clock generation circuitry 250 generates an updated clock signal based on the phase adjusted indicated by the control signal 237.

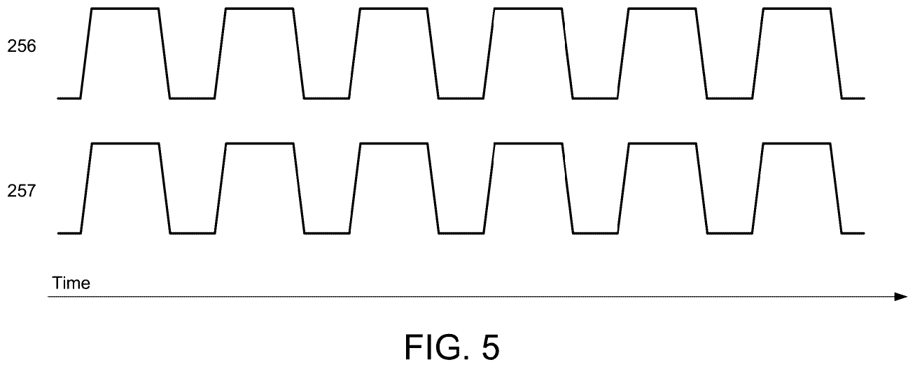

At operation 360 of the method 300, a determination if the updated clock signal is aligned with the track signal is made. In one example, the updated clock signal is compared to the track signal 2237 as is described above with regard to operation 330 of FIG. 3. Based on the determination that the updated clock signal is aligned with the track signal at operation 360, the method 300 proceeds to operation 370. FIG. 5 illustrates the clock signal 256 being aligned with the track signal 257.

At operation 370 of the method 300, the clock signal adjustment process is stopped. For example, the IC chip 220 instructs the IC chip 210 to stop outputting the track signal 257 via the control signal 235. For example, the buffer circuitry 255 receives the control signal 235, and stops outputting the track signal 257 based on the control signal 235.

At operation 360 of the method 300, based on the determination that the updated clock signal is not aligned with the track signal at operation 360, the method 300 proceeds to operation 340. The operations 340, 350, and 360 are iteratively repeated until the updated clock signal is determined to be aligned with the track signal.

In one or more examples, the method 300 provides a process for mitigating drift within a clock signal of a first IC die by adjusting the phase of the clock signal in a second IC die. Accordingly, drift within a clock signal can be detected in runtime. Further, as the clock signal is adjusted in the second IC die, the circuit area of the receiver circuitry and complexity of the receiver circuitry of the first IC die is decreased, decreasing the semiconductor manufacturing costs of the first IC die.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A C2C interface is used to communicate data in a multi-chip IC device. Further, a clock signal, or signals, is transmitted between the IC chips of a multi-chip IC device. Overtime, the clock signals may exhibit drift, introducing errors within the data communicated between the IC chips. The drift is due to changes in operating temperature and/or voltages within the IC chips. As is described above, a track signal generated and output by a first IC chip is used to detect clock signal drift at a second IC chip. The second IC chip instructs the first IC chip to adjust the phase of the clock signal based on the detected drift, to mitigate the drift. Accordingly, the circuit area and design complexity of the second IC chip is reduced, reducing the semiconductor manufacturing costs of the IC chips.

While the foregoing is directed to specific examples, other and further examples may be devised without departing from the basic scope thereof, and the scope thereof is determined by the claims that follow.

What is claimed is:

1. A multi-chip integrated circuit (IC) device, comprising:
a first IC chip; and
a second IC chip connected to the first IC chip via interface circuitry, wherein the second IC chip is configured to:
receive a clock signal and a track signal from the first IC chip;
output a first control signal to the first IC chip, the first control signal including an indication to adjust the clock signal based on determining that the clock signal is not aligned with the track signal; and
receive the adjusted clock signal from the first IC chip.

2. The multi-chip IC device of claim 1, wherein the second IC chip is further configured to compare the track signal with the clock signal to determine that the clock signal is not aligned with the track signal.

3. The multi-chip IC device of claim 1, wherein the clock signal differs in phase from the track signal.

4. The multi-chip IC device of claim 1, wherein the second IC chip is further configured to output a track control signal to the first IC chip, the track control signal includes an indication to output the track signal from the first IC chip to the second IC chip.

5. The multi-chip IC device of claim 4, wherein the first IC chip is configured to receive the track control signal and output the track signal to the second IC chip based on receiving the track control signal.

6. The multi-chip IC device of claim 1, wherein the first IC chip is configured to receive the first control signal and adjusts a phase of the clock signal based on the first control signal, and output the adjusted clock signal to the second IC chip.

7. The multi-chip IC device of claim 6, wherein adjusting the phase of the clock signal includes increasing or decreasing the phase of the clock signal by one or more steps based on the first control signal.

8. The multi-chip IC device of claim 1, wherein the interface circuitry is Universal Chiplet Interconnect express (UCIe) interface circuitry.

9. The multi-chip IC device of claim 1, wherein the second IC chip is configured to receive and process a data signal communicated by the first IC chip via the interface circuitry using the adjusted clock signal.

10. An integrated circuit (IC) chip configured to:
receive a clock signal and a track signal from the a second IC chip, wherein the second IC chip is connected to the IC chip via interface circuitry;
output a first control signal to the second IC chip, the first control signal including an indication to adjust the clock signal based on determining that the clock signal is not aligned with the track signal; and
receive the adjusted clock signal from the second IC chip.

11. The IC chip of claim 10, further configured to compare the track signal with the clock signal to determine that the clock signal is not aligned with the track signal.

12. The IC chip of claim 10, further configured to output a track control signal to the second IC chip, the track control signal includes an indication to output the track signal from the first IC chip to the second IC chip.

13. The IC chip of claim 12, wherein the second IC chip is configured to receive the track control signal and output the track signal to the second IC chip based on receiving the track control signal.

14. The IC chip of claim 10, wherein the second IC chip is configured to receive the first control signal and adjust a phase of the clock signal based on the first control signal, and output the adjusted clock signal to the IC chip.

15. A method comprising:
receiving, at a first integrated circuit (IC) chip, a clock signal and a track signal from a second IC chip, the first IC chip connected to the second IC chip via interface circuitry;
outputting, from the first IC chip, a first control signal to the second IC chip, the first control signal including an indication to adjust the clock signal based on determining that the clock signal is not aligned with the track signal; and
receiving, at the first IC chip, the adjusted clock signal from the second IC chip.

16. The method of claim 15, further comprising comparing, by the first IC chip, the track signal with the clock signal to determine that the clock signal is not aligned with the track signal.

17. The method of claim 15, further comprising:
outputting a track control signal from the first IC chip to the second IC chip, wherein the second IC chip outputs the track signal based on receiving the track control signal.

18. The method of claim 15, further comprising:
adjusting, by the second IC chip, a phase of the clock signal based on receiving the first control signal; and
outputting the adjusted clock signal from the second IC chip to the first IC chip.

19. The method of claim 15, wherein the interface circuitry is Universal Chiplet Interconnect express (UCIe) interface circuitry.

20. The method of claim 15, further comprising receiving and processing a data signal, by the first IC chip, communicated by the second IC chip via the interface circuitry using the adjusted clock signal.
